(19) United States
(12) Patent Application Publication
(10) Pub. No.: US 2004/0155839 A1
(43) Pub. Date: Aug. 12, 2004

(54) Scan driving apparatus and method of field emission display device

(75) Inventor: Seong Hak Moon, Seoul (KR)

Correspondence Address: JONATHAN Y. KANG, ESQ., LEE, HONG, DEGERMAN, KANG & SCHMADEKA, 14TH FLOOR, 801 S. FIGUEROA STREET, LOS ANGELES, CA, 90017, US

(73) Assignee: LG Electronics Inc.

(21) Appl. No.: 10/765,308

(22) Filed: Jan. 26, 2004

(30) Foreign Application Priority Data
Jan. 27, 2003 (KR) 05287/2003
Jul. 18, 2003 (KR) 49338/2003
May 23, 2003 (KR) 33060/2003

(51) Int. Cl. G09G 3/22

(52) U.S. Cl. 345/75.2

(57) ABSTRACT

A scan driving apparatus of a field emission display device includes: a pulse generator for outputting a prescribed level of voltage through ON/OFF operation of a plurality of switching units; and a scan driving IC for receiving the prescribed level of voltage from the pulse generator and selectively outputting it to an external display panel. A delay time of a scan pulse can be reduced, a crosstalk due to an overlap phenomenon according to time repetition between scan lines can be reduced, a life span of a cell can be lengthened, and a uniformity of the cell can be enhanced.

### BACKGROUND OF THE INVENTION

1. Field of the Invention

The present invention relates to a display device and, more particularly, to a scan driving apparatus and method of a field emission display device capable of enhancing a stable operation and uniformity of a cell by removing an electric charge accumulated in the cell when a panel is driven.

2. Description of the Background Art

With the rapid development in the information telecommunication technology, an electronic display device is increasing in its demand in order to meet the request for visualization of diverse information. For example, a light, small and less power-consumed display device is favored for an environment emphasizing a mobility such as a mobile information device, while a display device with a wide angular field is favored for information notification for the public.

In order to satisfy such requirements, the display device should necessarily be large in size, low-priced, highly performed, thin and light, and thus, development of a light, thin flat panel display device that can replace the existing CRT is in dire need.

The CRT, mostly used for the information display medium presently, is excellent in its performance, but as its screen is enlarged, volume and weight of the CRT are accordingly increased and a high voltage and high power consumption are also problematic. Therefore, a flat panel display inevitably comes to the front.

Among flat panel display devices that are under development or manufacturing, a liquid crystal display (LCD), a plasma display panel (PDP) and a vacuum fluorescent Display (VFD) are being commercialized by some big manufacturers.

In addition, a field emission display (FED), which is expected to be put to practical use in the near future, receives an attention as a next-generation information telecommunication flat panel display device overcoming shortcomings of those display devices.

Especially, an MIM (Metal-Insulator-Metal Field Emission Display) is advantageous in that it operates at a high speed and has a perfect color, a perfect gray scale, a high luminance and a high image transmission speed.

FIG. 1 is a sectional view showing a cell structure of a field emission display device in accordance with a conventional art.

As shown in FIG. 1, the cell of the conventional field emission display device includes an upper glass substrate 10, a lower glass substrate 16 and a field emission array 17 formed on the lower glass substrate 16. The upper glass substrate includes an anode electrode 11 and a fluorescent material 12, and the field emission array 17 includes a scan electrode 15 formed on the lower glass substrate 16 and emitting electrons, an insulation layer 14 formed on the scan electrode 15, and a data electrode 13 formed on the insulation layer 14 and generating an electric field to control the strength of the electrons.

For an image display of the field emission display device, a positive (+) anode voltage is applied to the anode electrode 11 formed on the upper substrate, a negative (−) scan pulse is applied to the scan electrode 15 formed on the lower substrate, and a positive (+) data pulse is applied to the data electrode 13.

Accordingly, electrons discharged from the scan electrode tunnel their way out of an insulation layer and are accelerated to the fluorescent material 12.

As the accelerated electrons collide with red, green and blue fluorescent material 12, an energy is generated, by which electrons in the fluorescent material 12 are excited and radiated. At this time, a visible light of one of red, green and blue colors is emitted according to the fluorescent material 12 to display an image.

FIG. 2 is a schematic block diagram showing the construction of a driving unit of the conventional field emission display device.

As shown in FIG. 2, the conventional field emission display device includes a controller 23 for receiving horizontal and vertical synchronous signal (H, V sync) of an inputted image signal (IN) and outputting a control signal; a data processor 21 for receiving the image signal, converting the image signal into image data and outputting the image data; a data driving unit 22 for receiving the image data from the data processor 21 and outputting a data pulse; a scan driving unit 24 for receiving the control signal from the controller 23 and outputting a scan pulse; and a panel 25 for receiving the data pulse from the data driving unit 22 and the scan pulse from the scan driving unit 24 and displaying the image signal.

FIG. 3 illustrates driving waveforms supplied to the field emission display device, and FIG. 4 is an exemplary view showing disposition of pixel cells of the field emission display device.

As shown in FIGS. 3 and 4, in the conventional field emission display device, a negative (−) scan pulse (SP) is sequentially supplied to scan electrodes (SCAN 1˜SCAN m) and a positive (+) data pulse (DP) in synchronization with the scan pulse (SP) is supplied to data electrodes (DATA 1˜DATA n). Accordingly, in a pixel cell to which the scan pulse (SP) and the data pulse (DP) have been supplied, electrons are discharged due to a voltage difference between the scan pulse (SP) and the data pulse (DP).

For example, if a −5V of scan pulse (SP) is applied to the first scan electrode (SCAN 1) and a 5V of data pulse (DP) is applied to the data electrode (DATA 1), 10V of voltage difference is made in a first pixel cell (P1) formed in the first scan electrode. Thus, electrons are discharged from the first pixel cell P1 to which the data pulse (DP) has been supplied. And, at this time, since only 5V of data pulse (DP) is applied to the second pixel to the mth pixel cell (P2˜Pm) where a second scan electrode and the mth scan electrode (SCAN 2˜SCAN m) are formed, no electrons are discharged.

The width and/or amplitude of the data pulse (DP) are/is set to be different according to gray scale. In other words, the width and/or amplitude of the data pulse (DP) are/is set wide or high to express a high gradation, or set narrow or low in order to express a low gradation.

Thereafter, the above-described process is repeatedly performed to sequentially apply the scan pulse (SP) and the data pulse (DP) to drive the first pixel cell to the mth pixel cell (P1˜Pm) to display an image.

After the image is displayed, a positive reset pulse (RP) is applied to the first scan electrode to the mth scan electrode (SCAN 1˜SCAN m) to remove an electric charge charged in the first pixel cell to the mth pixel cell (P1˜Pm).

However, in the conventional field emission display device, when the first scan electrode is driven, a data pulse is applied also to the second scan electrode to the mth scan electrode. Thus, a certain voltage is applied to the data pulse-received second scan electrode to the mth scan electrode, and a capacitance value of the pixel cells is increased due to the certain voltage. This phenomenon also occurs when the pixel cells formed in the second scan electrode to the mth scan electrode are driven.

In addition, as the screen widens in its size, rising time of the scan pulse lengthens due to a high scan electrode resistance existing in the scan line and a high value of condenser component existing in the cell, and since it overlaps with a scan pulse applied to an adjacent scan line, a picture quality deteriorates.

Moreover, in a state that an electric charge is not completely discharged after being charged in a cell, if a new voltage is applied to the cell, a previous voltage and the new voltage would be added according to a load. Then, an actual capacitor value applied to the cell is much increased, causing a phenomenon that images between adjacent cells or frames overlap with each other, so a uniformity of the entire screen deteriorates.

Furthermore, since the capacitor value is much increased, a peak current is increased to damage a dielectric layer of the display device, causing problems that a life span or an efficiency of the cell is degraded.

### SUMMARY OF THE INVENTION

Therefore, one object of the present invention is to provide a scan driving apparatus and method of a field emission display device capable of reducing a crosstalk due to an overlap phenomenon according to temporal repetition between scan lines, lengthening a life span of a cell and enhancing a uniformity of the cell by applying a reset pulse to a scan electrode to discharge an electric charge existing in the cell.

Another object of the present invention is to provide a scan driving apparatus and method of a field emission display device capable of preventing occurrence of a voltage difference between cells, enhancing a uniformity between cells and reducing a delay time of a scan pulse by simultaneously applying a plurality of reset pulses to every scan electrode to discharge an electric charge existing in a cell.

Still another object of the present invention is to provide a scan driving apparatus and method of a field emission display device capable of enhancing a uniformity of an entire screen, for which after a scan pulse is applied, a positive reset pulse is applied from a point when the scan pulse is completed in order to sharply raise a rising tilt to discharge an electric charge charged in a cell.

Yet another object of the present invention is to provide a scan driving apparatus and method of a field emission display device capable of preventing a leakage current from flowing to a data electrode by first supplying a positive reset pulse to a scan electrode before supplying a scan pulse thereto or first supplying a negative reset pulse to the data electrode before supplying a data pulse thereto.

To achieve these and other advantages and in accordance with the purpose of the present invention, as embodied and broadly described herein, there is provided a scan driving apparatus of a field emission display device including: a pulse generator for outputting a prescribed level of voltage through ON/OFF operation of a plurality of switching units; and a scan driving IC for receiving the prescribed level of voltage from the pulse generator and selectively outputting it to an external display panel.

To achieve the above objects, there is also provided a scan driving apparatus of a field emission display device including: a timing controller for receiving an external control signal and outputting a timing control signal and a plurality of switching control signals; a pulse generator having a plurality of switching units and outputting two or more prescribed levels of voltages as the switching units are turned on/off by a plurality of switching control signals outputted from the timing controller; and a scan driving IC having a plurality of driving ICs, receiving by different input terminals two or more prescribed level of voltages outputted from the pulse generator, and selectively outputting one of the two or more prescribed level of voltages to a panel according to the timing control signal outputted from the timing controller.

To achieve the above objects, there is also provided a scan driving apparatus of a field emission display device including: a timing controller for receiving an external control signal and outputting a timing control signal and a plurality of switching control signals; a pulse generator for turning on/off a switching unit upon receiving the switching control signal and outputting a prescribed level of voltage; and a scan driving IC for receiving the timing control signal from the timing controller and selectively outputting a prescribed level of voltage outputted from the pulse generator.

To achieve the above objects, there is also provided a field emission display device including: a data driving unit for preventing a leakage current from flowing to a data electrode by previously supplying a negative reset pulse to the data electrode before supplying a data pulse thereto; and a scan driving apparatus for previously supplying a reset pulse to a scan electrode before supplying a scan pulse thereto.

To achieve the above objects, there is also provided a scan driving method of a field emission display device in which a data pulse is applied to a data electrode and a scan pulse and a reset pulse are alternately applied to a scan electrode, including: a step in which when a reset pulse is applied to one of a plurality of scan electrodes, the reset pulse is also applied to all the remaining scan electrodes.

To achieve the above objects, there is also provided a scan driving method of a field emission display device in which a data pulse is applied to a data electrode and a scan pulse and a reset pulse are alternately applied to a scan electrode, including: a step in which a scan pulse and a reset pulse are alternately applied to one scan line constituting a panel of the display device; and a step in which when a reset pulse is applied to one scan line, the reset pulse is applied also to other remaining scan lines constituting the display panel.

To achieve the above objects, there is also provided a scan driving method of a field emission display device in which a data pulse is applied to a data electrode and a scan pulse and a reset pulse are alternately applied to a scan electrode, including: applying a scan pulse in synchronization with the data pulse to the scan electrode and applying a reset pulse having a certain voltage to the scan electrode at a point when the scan pulse rises.

To achieve the above objects, there is also provided a scan driving method of a field emission display device in which a data pulse is applied to a data electrode and a scan pulse and a reset pulse are alternately applied to a scan electrode, including: supplying a data pulse to a plurality of data electrode; sequentially supplying a scan pulse in synchronization with the data pulse to a plurality of scan electrodes; and supplying a plurality of positive sawtooth waveform reset pulses to the plurality of scan electrodes or supplying a plurality of negative sawtooth waveform reset pulses to the plurality of data electrodes, in order to get rid of the electric charge charged in a cell to which the scan pulse and data pulse have been supplied.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a cell structure of a field emission display device in accordance with a conventional art;

FIG. 2 is a schematic block diagram showing a construction of a driving unit of the field emission display device in accordance with the conventional art;

FIG. 3 illustrates driving waveforms supplied to the field emission display device in accordance with the conventional art;

FIG. 4 is an exemplary view showing a disposition of a pixel cell of the field emission display device in accordance with the conventional art;

FIG. 5 is a block diagram showing a construction of a scan driving apparatus of a field emission display device in accordance with the present invention;

FIG. 6 is an exemplary view showing a pulse generator and a scan driving IC of a scan driving apparatus in accordance with the present invention;

FIG. 7 illustrates waveforms of a scan pulse and a reset pulse applied to a panel of the field emission display device in accordance with the present invention;

FIG. 8 is a block diagram showing a construction of a scan driving apparatus of a field emission display device in accordance with another embodiment of the present invention;

FIG. 9 illustrates waveforms applied to the panel of the field emission display device in accordance with the present invention;

FIG. 10 shows comparison between a waveform applied to the panel in accordance with the present invention and a waveform in accordance with the conventional art;

FIG. 11 is an exemplary view showing a scan driving apparatus (the pulse generator and the scan driving IC) of the field emission display device in accordance with the present invention;

FIG. 12 shows a construction of a data driving unit of the of the field emission display device in accordance with the present invention;

FIG. 13 illustrates a reset waveform and a waveform of a scan pulse in accordance with the present invention; and

FIG. 14 illustrates a reset waveform and a waveform of a data pulse in accordance with the present invention.

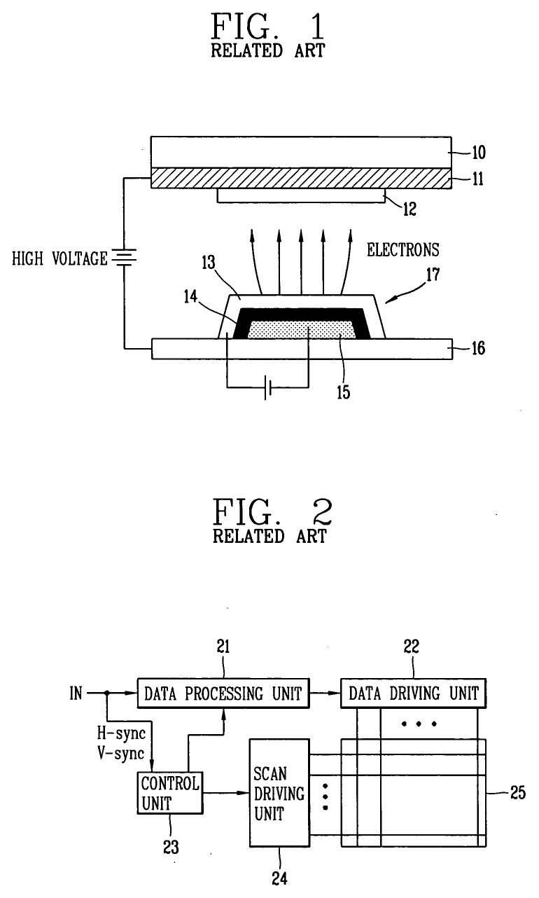

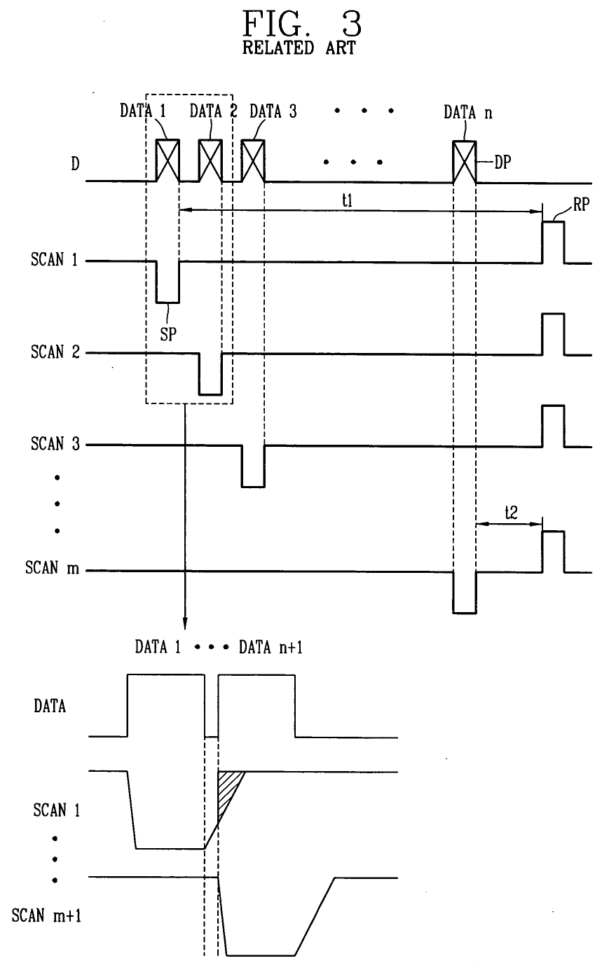

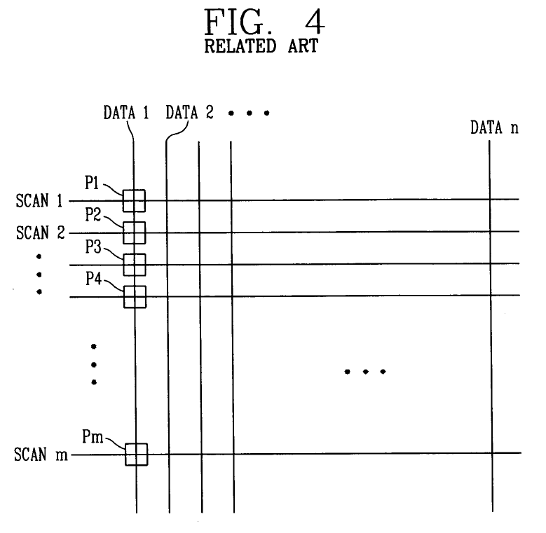

### DETAILED DESCRIPTION OF THE PREFERRED EMBODIMENTS

Reference will now be made in detail to the preferred embodiments of the present invention, examples of which are illustrated in the accompanying drawings.

In a field emission display device in accordance with the present invention, an electric charge existing in a cell is discharged by applying a reset pulse to a scan electrode. Accordingly, since a crosstalk taking place due to an overlap phenomenon according to a time repetition between scan lines can be reduced, the field emission display device includes a scan driving apparatus capable of enhancing a uniformity of the cell and extending a life span of the cell.

The scan driving apparatus of the field emission display device in accordance with the present invention will now be described in detail.

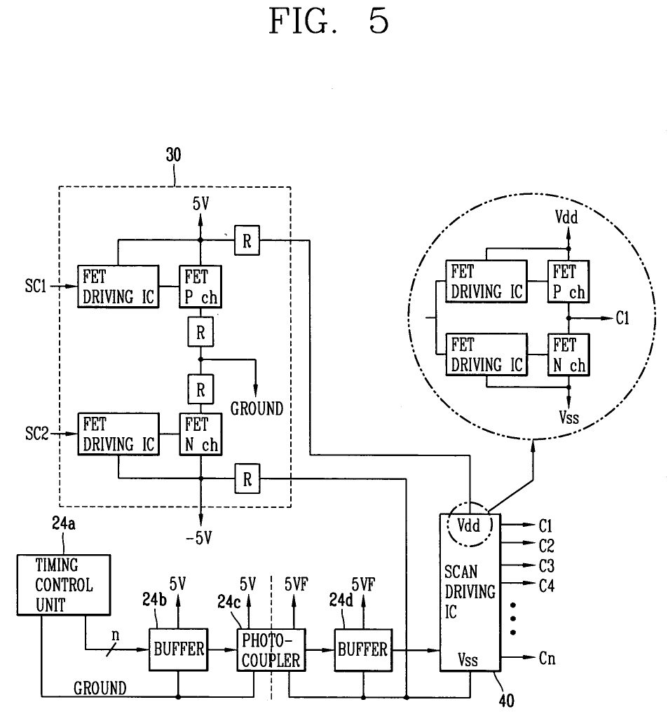

FIG. 5 is a block diagram showing a construction of a scan driving apparatus of a field emission display device in accordance with the present invention.

As shown in FIG. 5, the scan driving apparatus of the field emission display device in accordance with the present invention includes: a timing controller 24a for outputting a timing control signal according to an external control signal; a buffer 24b for receiving the timing control signal from the timing controller 24a, temporarily storing it, and amplifying and outputting the stored signal; a photocoupler 24c electrically divided into a primary side and a secondary side, receiving the timing control signal from the buffer 24b and transmitting it to the secondary side; a buffer 24d for receiving the timing control signal from the photocoupler 24c, temporarily storing it, and amplifying and outputting the timing control signal; a pulse generator 30 having a switching unit, and outputting certain levels of voltages as the switching unit is switched on/off according a switching control signal received from the timing controller 24a or an external control signal; and a scan driving IC 40 having a plurality of driving ICs, receiving the certain levels of voltages through a Vdd terminal and a Vss terminal from the pulse generator 30 according to the timing control signal received from the timing controller 24a, and selectively outputting one of the certain levels of voltages to an external display panel (not shown).

Preferably, the pulse generator includes two switching units and outputs two voltages each having a certain level.

The driving IC of the scan driving IC, preferably consisting of two switching units, turns on only one switching unit upon receiving the timing control signal from the buffer 24d and outputs one of two voltages outputted from the pulse generator 30.

Namely, one driving IC includes two FETs (Field Effect Transistor), each having a different channel (n channel and p channel), as a push-pull type switch so that when one of the two switching units is turned on, the other is turned off.

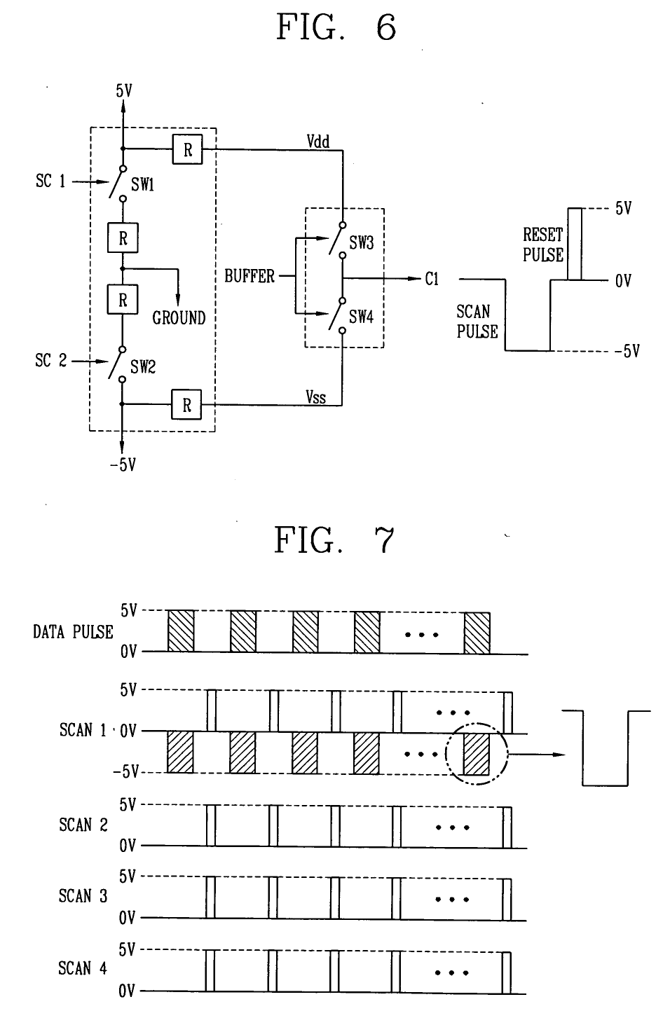

FIG. 6 is an exemplary view showing a pulse generator and a scan driving IC of a scan driving apparatus in accordance with the present invention.

As shown in FIG. 6, the scan driving apparatus in accordance with the present invention includes two FET switches constituting the pulse generator 30 and one FET switch constituting the scan driving IC 40.

Herein, the FET turned on/off by a first switching control signal SC1 is referred to as SW1, an FET turned on/off by a second switching control signal SC2 is referred to as SW2, and two FETs turned on/off by the timing control signal received from the timing controller 24a are referred to as SW3 and SW4.

The operation of the present invention by using the four switches SW1, SW2, SW3 and SW4 will now be described.

First, referring to a process of outputting a scan pulse in synchronization with a data pulse received from the data driving unit (not shown), zero voltage (0V), a ground voltage, can be outputted by turning on SW1 and SW3.

In addition, in order to output a −5V of voltage, the SW2 is turned off, a 5V of voltage is inputted to Vss terminal of the scan driving IC 40, and the FET of the driving IC connected to the Vss terminal, that is, SW4 is turned on, thereby forming a scan pulse waveform corresponding to −5V.

After the scan pulse is outputted, a reset pulse is outputted after a pre-set time lapse. In this case, the reset pulse with 0V, the ground voltage, can be outputted from the scan pulse by turning on the switches SW2 and SW4.

In order to output a voltage 5V, SW1 is turned off to input 5V of voltage to the Vdd terminal of the scan driving IC 40 and the FET of the driving IC connected to the Vdd terminal, that is, SW3, is turned on, thereby forming a reset pulse waveform corresponding to 5V.

In order to make the scan pulse and the reset pulse 0V, SW2 and SW4 are turned on in case of the scan pulse, while SW1 and SW3 are turned on in case of the reset pulse.

However, in this case, since the two voltages of the scan pulse and the reset pulse are inputted through the same terminal, a time delay of the pulse inevitably occurs. In this manner, the scan pulse and the reset pulse may differ according to an input form of the switching control signals (SC1 and SC2) inputted from an external source and the timing control signal.

And, in outputting the reset pulse, the reset pulse is outputted to every scan electrode constituting a panel (not shown) as well as to the scan electrode inputting the scan pulse.

FIG. 7 illustrates waveforms of a scan pulse and a reset pulse applied to a panel of the field emission display device in accordance with the present invention.

As shown in FIG. 7, when −5V is increased to 0V, the scan pulse waveform in the present invention quickly rises without a time delay, compared to the waveform in the conventional art. In other words, in the conventional art, since 0V and −5V are inputted to the same terminal, that is, to the Vss terminal, the time delay occurs, but in the present invention, 0V is inputted to the Vdd terminal and −5V is inputted to the Vss terminal, thereby solving the problem of time delay.

In addition, in the conventional art, after the scan pulses are all applied to one scan line, the reset pulse is applied, but in the present invention, the reset pulse is applied between cells, that is, between scan pulses. At this time, the reset pulse is applied for blanking signal interval, not an image signal interval, so it does not affect a horizontal period time. In addition, the same type of reset pulse is applied to a different scan line to which the scan pulse is not applied. Accordingly, the electric charge accumulated in the cell can be completely discharged, so that the uniformity can be enhanced and the crosstalk between adjacent scan lines can be prevented.

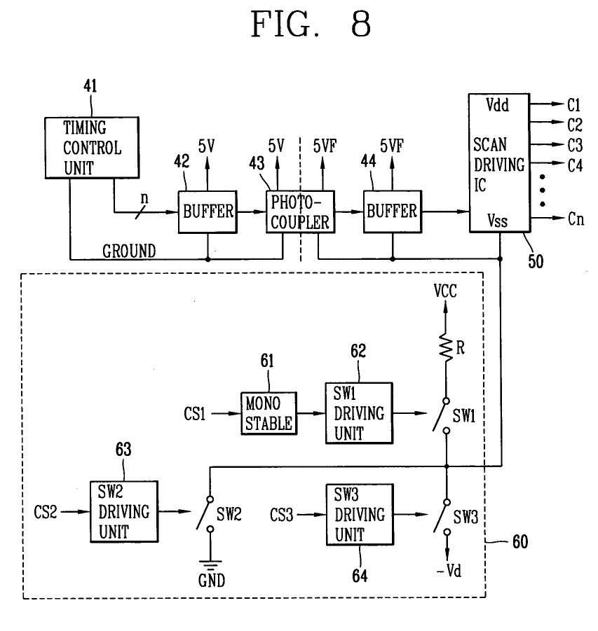

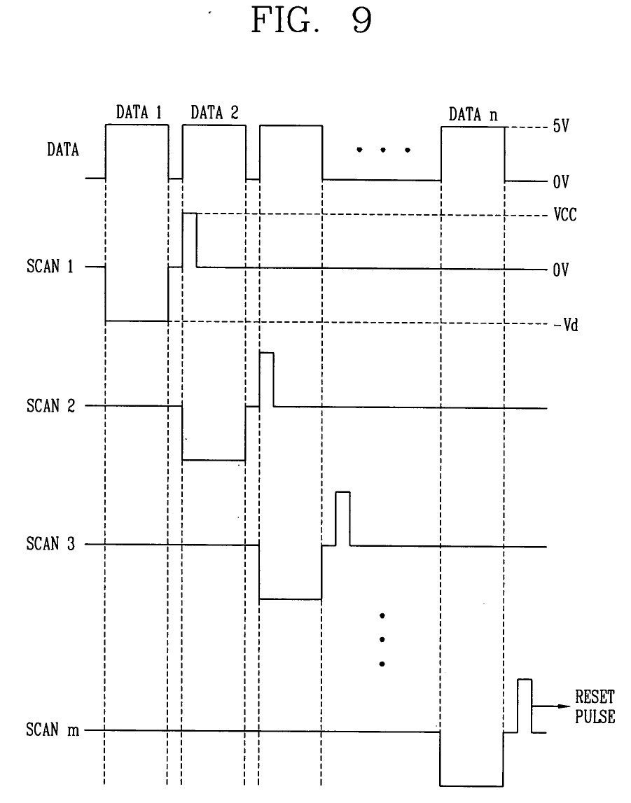

FIG. 8 is a block diagram showing a construction of a scan driving apparatus of a field emission display device in accordance with another embodiment of the present invention.

As shown in FIG. 8, the scan driving apparatus in accordance with the present invention includes: a timing controller 41 for receiving an external control signal and outputting a timing control signal and a plurality of switching control signal; a buffer 42 for receiving the timing control signal from the timing controller 41, temporarily storing it, amplifying the timing control signal, and outputting the amplified timing control signal; a photocoupler 43 electrically divided into a primary side and a secondary side, receiving the timing control signal from the buffer 42 and transmitting it to the second side; a buffer 44 for temporarily storing the timing control signal received from the photocoupler 43, amplifying the timing control signal, and outputting the amplified timing control signal; a pulse generator 60 having a plurality of switching units SW1, SW2 and SW3 and a monostable multimvibrator 61, and outputting a certain level of voltage by turning on/off the switching units upon receiving a plurality of switch control signals CS1, CS2 and CS3 from an external source (a controller); and a scan driving IC 50 for selectively outputting a certain level of voltage received from the pulse generator 60 according to the timing control signal received from the buffer 44.

The pulse generator 60 additionally includes a plurality of switch driving units (SW1, SW2 and SW3 driving units) 62, 63 and 64 for respectively controlling the plurality of switching units SW1, SW2 and SW3, and a resister (R) for controlling a tilt of a positive voltage (Vcc) outputted from the switching unit SW1.

The monostable multivibrator 61 controls the switching unit SW1 driving unit by forming a waveform with different time and phase.

The operation of the present invention can be divided into a scan pulse driving and a reset pulse driving.

First, in order to output a scan pulse to a scan line of the panel, when the switching unit SW3 is turned on under the control of the switching unit SW3 driving unit upon receiving the switching control signal CS3, a negative voltage (scan pulse) (−Vd) is outputted. In addition, the negative voltage is received from the Vss terminal of the scan driving IC 50 and applied to the scan line of the panel for a prescribed time period.

In order to output a reset pulse to the scan line, the monostable multivibrator 61 receives the switching control signal CS1 at a point when the scan pulse is finished, outputs a pulse with a certain frequency, and turns on the switching unit SW1 under the control of the SW1 driving unit by the outputted pulse at a point when the scan pulse rises.

As the switching unit SW1 is turned on, a reset pulse of a positive voltage (Vcc) is outputted through the resister (R), and the reset pulse of the positive voltage is applied to the scan line of the panel through the Vss terminal of the scan driving IC 50. In other words, since the Vcc voltage, the reset pulse, is supplied to the scan line of the panel through the resister, the positive pulse having the sufficient current is applied, and thus, the current is sufficiently supplied and the electric charge is promptly supplied to the cell, so that the scan pulse rises quickly.

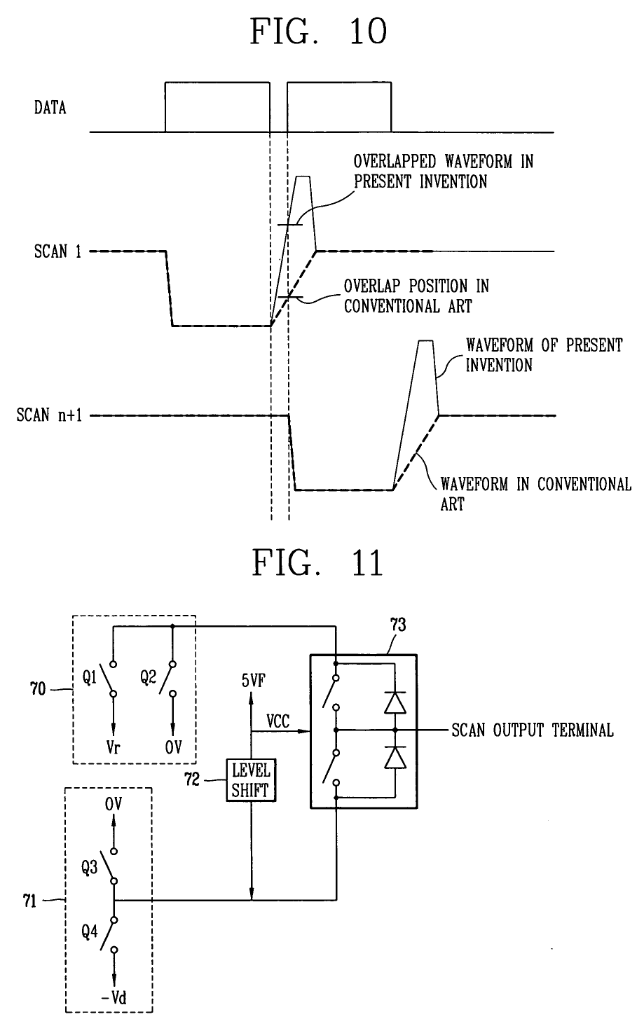

FIG. 9 illustrates waveforms applied to the panel of the field emission display device in accordance with the present invention.

As shown in FIG. 9, in the field emission display device in accordance with the present invention, a scan pulse in synchronization with a data pulse is applied to each scan line (SCAN1˜SCANm), and a reset pulse for quickly discharging the electric charge charged in the cell is then applied to the cell. Accordingly, the rising time of the scan pulse can quicken.

FIG. 10 shows comparison between a waveform applied to the panel in accordance with the present invention and a waveform in accordance with the conventional art.

As shown in FIG. 10, in the conventional art, since the reset pulse is applied after every scan pulse is applied, scan lines overlaps with each other when the scan pulse is placed at a negative position. Comparatively, however, in the present invention, the positive pulse (that is, the reset pulse) is automatically applied at a point when one scan pulse is finished, and accordingly, the rising time of the scan pulse can quicken.

Namely, in the conventional art, after the scan pulse drives the entire panel, the positive pulse is applied one time to the entire scan line, thereby performing resetting. Thus, the phenomenon that waveforms of scan lines overlap with each other can occur.

However, in the present invention, as for the reset pulse, a potential with a positive voltage (Vcc) is applied to the Vss terminal through the resister according to the operation of the SW1 driving unit and the switching unit SW1 at a point when the applied scan pulse rises. That is, when the positive pulse is applied, scan lines overlap with each other. Therefore, with a tilt of the scan pulse rapidly rising, the phenomenon that the adjacent scan lines overlap with each other is reduced.

Meanwhile, in a field emission display device in accordance with a different embodiment of the present invention, right before the scan pulse is applied to the cell constituting the panel, a reset pulse having a sawtooth waveform and an energy as strong as not to affect the cell is applied to discharge the electric charge charged in the cell. Then, even if a reverse bias is generated due to a phase difference between the waveform received from the data electrode and the waveform received from the scan pulse, a back current does not flow.

In other words, in order to reduce the crosstalk generated when the large-screen matrix type field emission display device, the plurality of sawtooth waveform reset pulses are supplied to the scan electrode before the scan pulse is applied to the scan electrode, thereby temporarily preventing a leakage current from flowing to the data electrode.

Likewise, in the data driving unit of the present invention, the negative sawtooth waveform reset pulse is applied in advance to the data electrode, thereby temporarily preventing a leakage current from flowing to the data electrode.

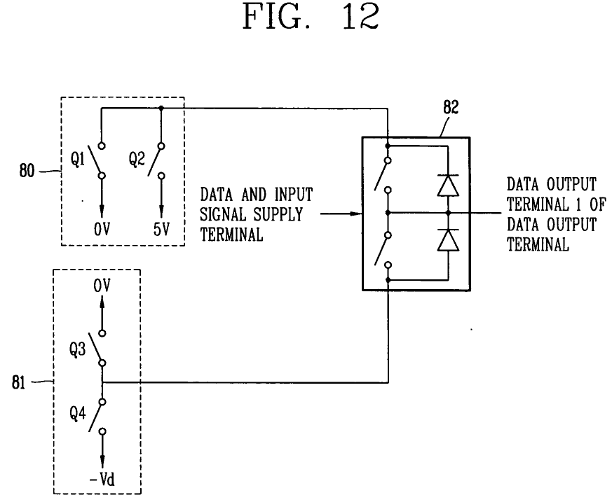

FIG. 11 is an exemplary view showing a scan driving apparatus (the pulse generator and the scan driving IC) of the field emission display device in accordance with the present invention.

As shown in FIG. 11, the scan driving apparatus includes a reset pulse generator 70, a scan pulse generator 71, a level shift 72 and a push-pull type switch 73 so that when one of two switching units is turned on, the other is turned off. The scan driving apparatus generates a positive sawtooth waveform reset pulse and applies it to the scan electrode. Herein, the sawtooth waveform reset pulse is applied between scan pulses applied to the ith (i is integer which is equal to or greater than ‘0’) scan electrode and (i+1)th scan electrode, and a phase of ith (i is integer which is equal to or greater than ‘0’) sawtooth waveform reset pulse which has finished dropping and a phase of the (i+1)th scan pulse which starts rising are the same.

The scan driving apparatus as constructed above operates as follows.

First, in order to apply the reset pulse, a switch Q1 of the reset pulse generator 70 is turned on and a switch Q2 of the reset pulse generator 70 is turned on or off to generate a reset pulse of Vr. In addition, in order to apply the scan pulse, the switch Q4 of the scan pulse generator 71 is turned on and the switch Q3 of the scan pulse generator 71 is turned on or off to generate a scan pulse of −Vd. In this case, a value of Vr and −Vd can be changed by a level shift. Thereafter, the generated reset pulse and the scan pulse are outputted to a scan output terminal according to an ON/OFF operation of the push-pull type switch 73.

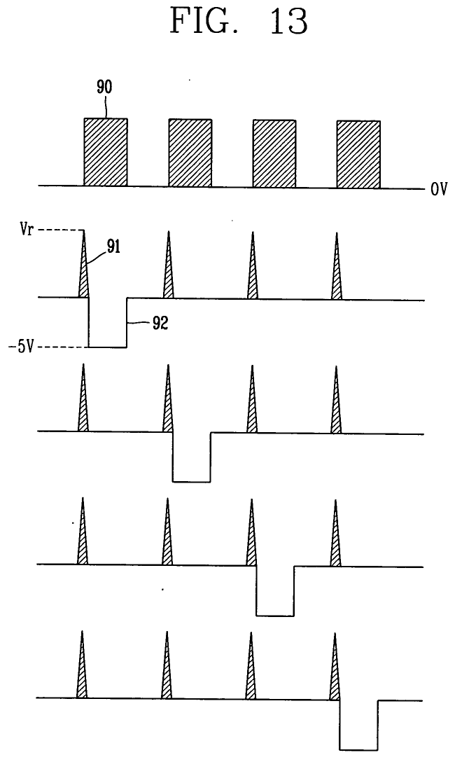

FIG. 12 shows a construction of a data driving unit of the of the field emission display device in accordance with the present invention.

As shown in FIG. 12, the data driving unit in accordance with the present invention includes a data pulse generator 80, a reset pulse generator 81 and a push-pull type switch 82, and generates and applies a negative sawtooth waveform reset pulse to the data electrode. The sawtooth waveform reset pulse is applied between data pulses which are applied to the ith (i is integer which is equal to or greater than ‘0’) data electrode and (1+1)th data electrode, and a phase of ith (i is integer which is equal to or greater than ‘0’) sawtooth waveform reset pulse which has finished dropping and a phase of the (i+1)th data pulse which starts rising are the same.

The data driving unit as constructed above operates as follows.

First, in order to apply the reset pulse, a switch Q4 of the reset pulse generator 81 is turned on and a switch Q3 of the reset pulse generator 81 is turned on or off to generate a sawtooth waveform reset pulse of −Vd. In addition, in order to generate a data pulse, a switch Q2 of the data pulse generator 80 is turned on and a switch Q1 of the data pulse generator 80 is turned on or off to generate a data pulse waveform of 5V. Thereafter, the generated reset pulse and the data pulse are outputted to the cell from a scan output terminal according to an ON/OFF operation of the push-pull type switch 82.

FIG. 13 illustrates a reset waveform and a waveform of a scan pulse in accordance with the present invention.

As shown in FIG. 13, a scan pulse 92 is applied to the scan electrode and a data pulse 90 in synchronization with the scan pulse is applied to the data electrode. Herein, right before the scan pulse 92 is applied, a plurality of positive sawtooth waveform reset pulses 91 are applied to the scan electrode. Thus, by applying the positive sawtooth pulse 91 to discharge the negative charge accumulated in the scan electrode, a leakage current can be prevented.

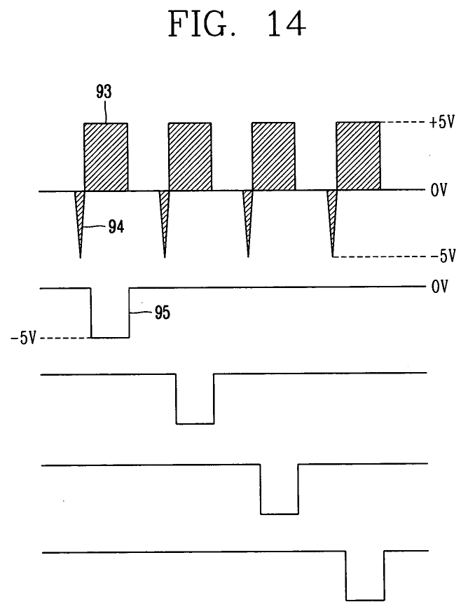

FIG. 14 illustrates a reset waveform and a waveform of a data pulse in accordance with the present invention.

As shown in FIG. 14, a scan pulse 95 is applied to the scan electrode and a data pulse 93 in synchronization with the scan pulse is applied to the data electrode. Herein, right before the data pulse is applied, a negative reset pulse 94 with sawtooth waveform is applied to the data electrode. Accordingly, by applying the negative sawtooth wave pulse 94 to discharge the positive electric charge charged in the data electrode by the data pulse 93, a leakage current can be prevented.

As so far described, the scan driving apparatus and method of a field emission display device of the present invention have the following advantages.

That is, for example, first, since the reset pulse is applied to the scan electrode to discharge the electric charge existing in the cell, a crosstalk due to an overlap phenomenon according to time repetition between scan lines can be reduced, a life span of the cell can be extended, and a uniformity of the cell can be enhanced.

Second, since a plurality of reset pulses are simultaneously applied to every scan electrode after a scan pulse is applied, the electric charge existing in the cell can be discharged, so that no voltage difference between cells is made, a uniformity between cells can be enhanced, and a delay time of the scan pulse can be reduced.

Third, after the scan pulse is applied, a positive reset pulse is applied starting from a point when one scan pulse is completed to sharply raise a rising time to quickly discharge the electric charge charged in the cell and thereby enhance a uniformity of the entire screen.

Fourth, by supplying the positive reset pulse to the scan electrode before supplying the scan pulse thereto or by supplying the negative reset pulse to the data electrode before supplying the data pulse thereto, a leakage current is prevented from flowing to the data electrode.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A scan driving method of a field emission display device in which a data pulse is applied to a data electrode and a scan pulse and a reset pulse are alternately applied to a scan electrode, including: a step in which when a reset pulse is applied to one of a plurality of scan electrodes, the reset pulse is also applied to all the remaining scan electrodes.

2. The method of claim 1, wherein the scan pulse applied to the scan electrode is synchronized with a data pulse applied to the data electrode.

3. The method of claim 1, wherein the scan pulse and the reset pulse are controlled by an external switching control signal and a timing control signal.

4. The method of claim 3, wherein the reset pulse is simultaneously applied to every scan electrode constituting the panel, after the scan pulse is applied.

5. The method of claim 4, wherein the reset pulse is applied to a blanking signal interval, not to an image signal interval.

6. The method of claim 1, wherein the reset pulse is applied between scan pulse and next scan pulse, and the reset pulse is simultaneously applied also to other remaining scan electrodes to which the scan pulse has not been applied.

7. The method of claim 1, wherein, a reset pulse having a positive voltage is applied when the scan pulse is completed, in order to sharply increase a tilt of a rising pulse of the scan pulse.

8. The method of claim 7, wherein the tilt of the rising pulse of the scan pulse is controlled by a resister provided in a pulse generator.

9. The method of claim 1, wherein before the scan pulse is applied to the scan electrode, a plurality of positive reset pulses with a sawtooth waveform are applied to the scan electrode.

10. The method of claim 9, wherein after the scan pulse is applied to one scan electrode, the positive reset pulse with the sawtooth waveform is applied to each of a plurality of scan electrodes.

11. The method of claim 9, wherein the sawtooth wave reset pulse is applied between scan pulses applied to the ith (i is integer which is equal to or greater than ‘0’) scan electrode and (i+1)th scan electrode.

12. The method of claim 11, wherein a phase of ith (i is integer which is equal to or greater than ‘0’) sawtooth waveform reset pulse which has finished dropping and a phase of the (i+1)th scan pulse which starts rising are the same.

13. The method of claim 1, wherein before the data pulse is applied to the data electrode, a plurality of negative sawtooth waveform reset pulses are applied to the data electrode.

14. The method of claim 13, wherein after the data pulse is supplied to the data electrode, the negative sawtooth waveform reset pulse is applied to each data electrode.

15. The method of claim 13, wherein the sawtooth waveform reset pulse is applied between data pulses applied to the the ith (i is integer which is equal to or greater than ‘0’) data electrode and (i+1)th data electrode.

16. The method of claim 15, wherein a phase of ith (i is integer which is equal to or greater than ‘0’) sawtooth waveform reset pulse which has finished dropping and a phase of the (i+1)th data pulse which starts rising are the same.

17. A scan driving method of a field emission display device in which a data pulse is applied to a data electrode and a scan pulse and a reset pulse are alternately applied to a scan electrode, comprising:
a step in which a scan pulse and a reset pulse are alternately applied to one scan line constituting a panel of the display device; and
a step in which when a reset pulse is applied to one scan line, the reset pulse is applied also to other remaining scan lines constituting the display panel.

18. A scan driving method of a field emission display device in which a data pulse is applied to a data electrode and a scan pulse and a reset pulse are alternately applied to a scan electrode, comprising:
applying a scan pulse in synchronization with the data pulse to the scan electrode and applying a reset pulse having a certain voltage to the scan electrode at a point when the scan pulse rises.

19. A scan driving method of a field emission display device in which a data pulse is applied to a data electrode and a scan pulse and a reset pulse are alternately applied to a scan electrode, comprising:
supplying a data pulse to a plurality of data electrode; sequentially supplying a scan pulse in synchronization with the data pulse to a plurality of scan electrodes; and
supplying a plurality of positive sawtooth waveform reset pulses to the plurality of scan electrodes or supplying a plurality of negative sawtooth waveform reset pulses to the plurality of data electrodes, in order to get rid of the electric charge charged in a cell to which the scan pulse and data pulse have been supplied.

20. The method of claim 19, wherein after the scan pulse is supplied to one scan electrode, the positive sawtooth waveform reset pulse is supplied to each of a plurality of scan electrodes.

21. The method of claim 19, wherein after the data pulse is supplied to one data electrode, the negative sawtooth waveform reset pulse is supplied to each of the plurality of data electrodes.

22. In a field emission display device having a data driving unit for applying a data pulse to a data electrode and a scan driving apparatus for alternately applying a scan pulse and a reset pulse to a scan electrode,
the scan driving apparatus comprising:
a pulse generator for outputting a prescribed level of voltage through ON/OFF operation of a plurality of switching units; and
a scan driving IC for receiving the prescribed level of voltage from the pulse generator and selectively outputting it to an external display panel.

23. The scan driving apparatus of claim 22, wherein the pulse generator includes two switching units, which respectively output two certain level of voltages by being turned on/off according to an external switching control signal.

24. The scan driving apparatus of claim 22, wherein the scan driving IC receives two or more prescribed level of voltages from the pulse generator by different input terminals.

25. The scan driving apparatus of claim 22, wherein the scan driving IC includes a plurality of driving ICs, each of which has two switching units so that when one switching unit is turned on, the other switching unit is turned off.

26. The scan driving apparatus of claim 25, wherein the driving IC receives two voltages with prescribed levels from the pulse generator and selectively outputs one of them to an external display panel.

27. The scan driving apparatus of claim 22 further comprising:
a timing controller for outputting a timing control signal according to an external control signal;
a buffer for receiving the timing control signal from the timing controller, temporarily storing it, and amplifying and outputting the stored signal;
a photocoupler electrically divided into a primary side and a secondary side, receiving the timing control signal from the buffer, and transferring the timing control signal to the secondary side; and
a buffer for receiving the timing control signal from the photocoupler, temporarily storing it, and amplifying and outputting the timing control signal.

28. The scan driving apparatus of claim 27, wherein the scan driving IC receives the two prescribed level of voltages from the pulse generator and selectively outputs one of them to the external display panel on the basis of the timing control signal received from the timing controller.

29. The scan driving apparatus of claim 22, wherein the pulse generator comprises:
a monostable multivibrator for outputting a certain frequency of pulse according to an external switching control signal;
a plurality of switch driving units for controlling the plurality of switching units according to the outputted pulse at a point when the scan pulse rises; and
a resister for controlling a tilt of a positive voltage outputted by the switching unit.

30. The scan driving apparatus of claim 22, wherein before the scan pulse is applied to the scan electrode, a plurality of positive sawtooth waveform reset pulses to the scan electrode.

31. The scan driving apparatus of claim 30, wherein before the data pulse is applied to the data electrode, a plurality of negative sawtooth waveform reset pulses are applied to the data electrode.

32. In a field emission display device having a data driving unit for applying a data pulse to a data electrode and a scan driving apparatus for alternately applying a scan pulse and a reset pulse to a scan electrode,
the scan driving apparatus comprising:
a timing controller for receiving an external control signal and outputting a timing control signal and a plurality of switching control signals;
a pulse generator having a plurality of switching units and outputting two or more prescribed levels of voltages as the plurality of switching units are turned on/off by a plurality of switching control signals outputted from the timing controller; and
a scan driving IC having a plurality of driving ICs, receiving by different input terminals two or more prescribed level of voltages outputted from the pulse generator, and selectively outputting one of the two or more prescribed level of voltages to a panel according to the timing control signal outputted from the timing controller.

33. The scan driving apparatus of claim 32, wherein each driving IC constituting the scan driving IC includes a plurality of switching units turned on/off by a timing control signal outputted from the timing controller.

34. In a field emission display device having a data driving unit for applying a data pulse to a data electrode and a scan driving apparatus for alternately applying a scan pulse and a reset pulse to a scan electrode,
the scan driving apparatus comprising:
a timing controller for receiving an external control signal and outputting a timing control signal and a plurality of switching control signals;
a pulse generator for turning on/off a switching unit upon receiving the switching control signal and outputting a prescribed level of voltage; and
a scan driving IC for receiving the timing control signal from the timing controller and selectively outputting a prescribed level of voltage outputted from the pulse generator.

35. The scan driving apparatus of claim 34, wherein the pulse generator comprises:
a monostable multivibrator for outputting a certain frequency of pulse according to the switching control signal;
a plurality of switch driving units for controlling the plurality of switching units; and
a resister for controlling a tilt of a positive voltage outputted by the switching unit.

36. A field emission display device comprising:
a data driving unit for preventing a leakage current from flowing to a data electrode by previously supplying a negative reset pulse to the data electrode before supplying a data pulse thereto; and
a scan driving apparatus for previously supplying a reset pulse to a scan electrode before supplying a scan pulse thereto.
